(19) United States
(12) Patent Application Publication
(10) Pub. No.: US 2007/0232151 A1
(43) Pub. Date: Oct. 4, 2007

(54) Electrical connector

(75) Inventor: Ted Ju, Anloku (TW)

Correspondence Address: BIRCH STEWART KOLASCH & BIRCH, PO BOX 747, FALLS CHURCH, VA, 22040-0747, US

(73) Assignee: Lotes Co., Ltd.

(21) Appl. No.: 11/582,365

(22) Filed: Oct. 18, 2006

(30) Foreign Application Priority Data
Apr. 3, 2006 (TW) 095205540

(51) Int. Cl. H01R 13/24

(52) U.S. Cl. 439/700

(57) ABSTRACT

The invention provides an electrical connector for enhancing the stability of contact between the terminals of the electrical connector and an electrical device. The electrical connector includes an insulator with a plurality of accommodating holes and a plurality of terminals, each of which is respectively disposed in one of the accommodating holes. Each of the terminals includes a first terminal, a second terminal, and a resilient member urging against the first terminal. The resilient member is disposed between the first terminal and the second terminal. Comparing with the current art, there is a better stability of electrically connection between the electrical device and the terminals of the electrical connector according to the invention.

### BACKGROUND OF THE INVENTION

1. Field of the Invention

This present invention relates to an electrical connector.

2. Description of the Prior Art

A current electrical connector includes an insulator and a plurality of terminals accommodated in the insulator. Each of the terminals includes a first terminal, a second terminal, and a resilient member between the first terminal and the second terminal. Therein, the first terminal is columnar, and the second terminal is a hollow column formed by deep drawing, of which the bottom end is closed, and the top end has a hole for the first terminal to insert into. The resilient member is disposed through the hole into the second terminal. To ensure that the first terminal can be inserted smoothly, the diameter of the first terminal is shorter than that of the hole, so the first terminal and the resilient member may swing in the second terminal and cause a bad contact between the terminals and an electrical device.

Therefore, there is a need to design a new electrical connector to solve the defects mentioned above.

### SUMMARY OF THE INVENTION

The scope of the present invention provides an electrical connector capable of enhancing the stability of contact between a terminal thereof and an electrical device.

To achieve the above scope, the electrical connector of the invention includes an insulator on which a plurality of accommodating holes are formed, and a plurality of terminals are accommodated in the accommodating holes. Each of the terminals includes a first terminal, a second terminal, and a resilient member urging against the first terminal. The resilient member is disposed between the first terminal and the second terminal.

Comparing with the prior art, the electrical connector of the invention has a better stability of electrical contact between the terminals and an electrical device.

The advantage and spirit of the invention may be further understood by the following description together with the appended drawings.

### BRIEF DESCRIPTION OF THE APPENDED DRAWINGS

FIG. 1 is an assembly diagram of an electrical connector of the invention.

FIG. 2 is an assembly diagram at another view of the electrical connector of the invention.

FIG. 3 is an external perspective view of an insulator of the electrical connector of the invention.

FIG. 4 is another external perspective view of the insulator of the electrical connector of the invention.

FIG. 5 is an assembly diagram of a terminal of the electrical connector of the invention.

FIG. 6 is a blown-up view of the terminal of the electrical connector of the invention.

FIG. 7 is another blown-up view of the terminal of the electrical connector of the invention.

### DETAILED DESCRIPTION OF THE INVENTION

The following further describes the invention with the attached figures and the embodiments.

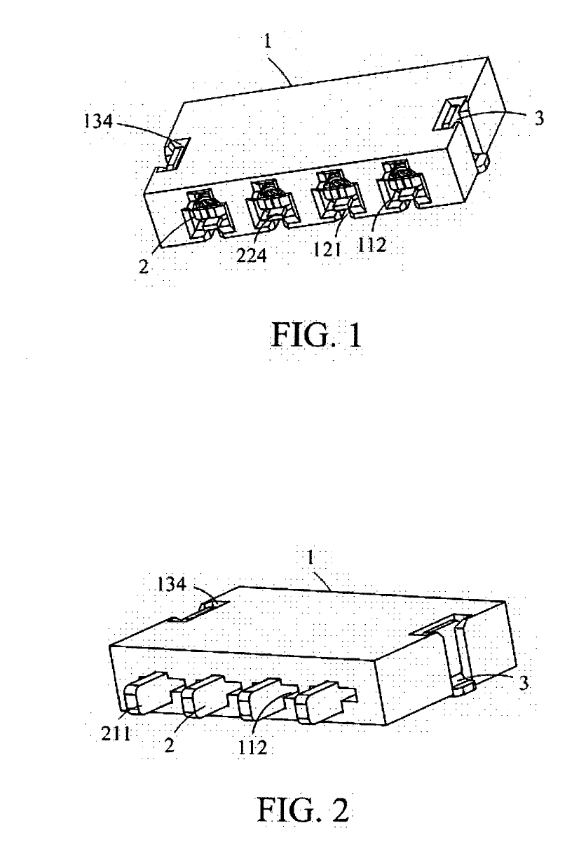

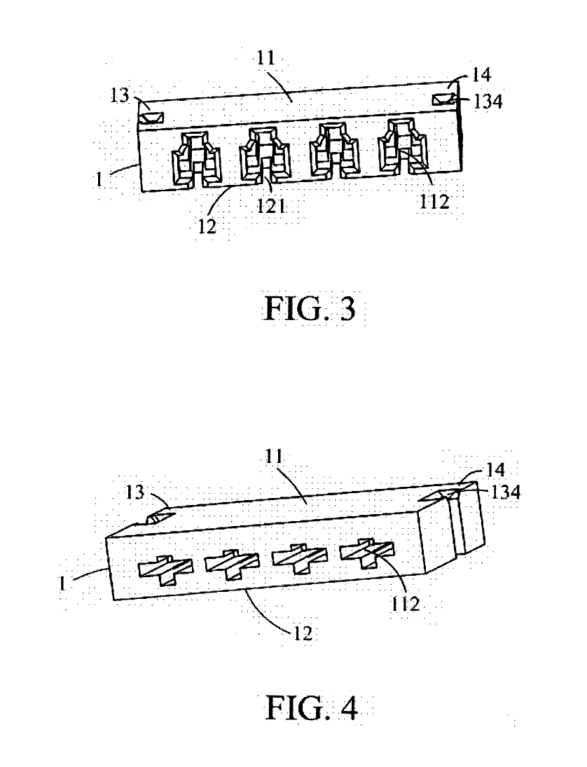

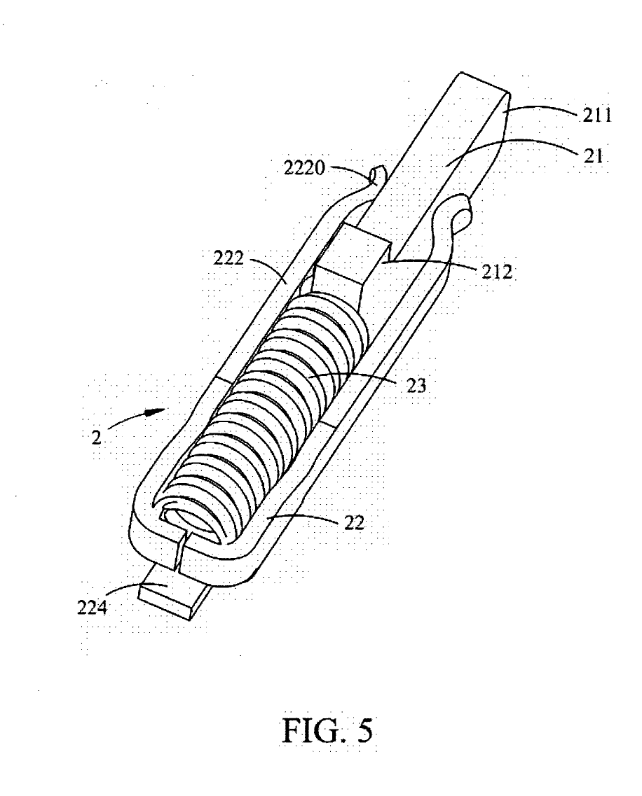

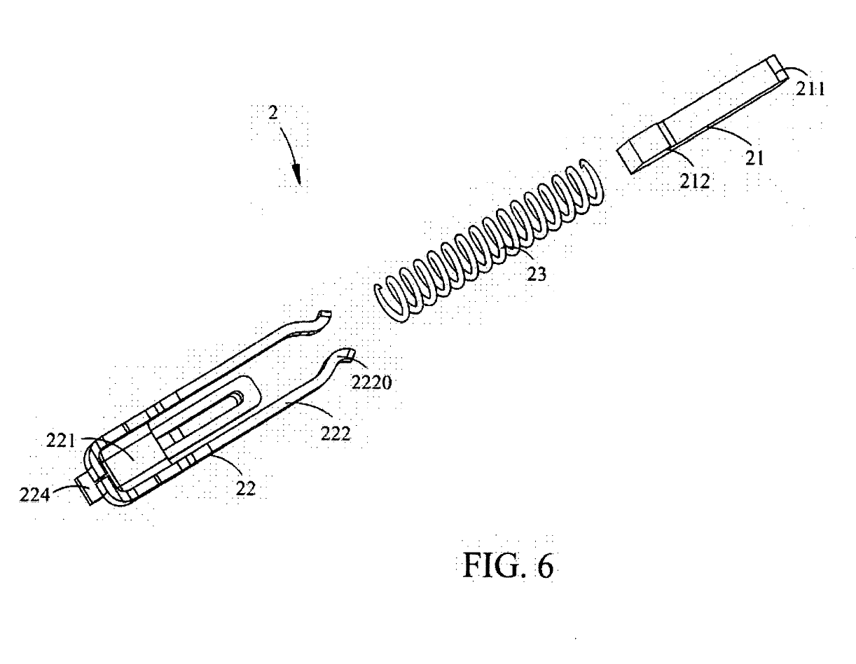

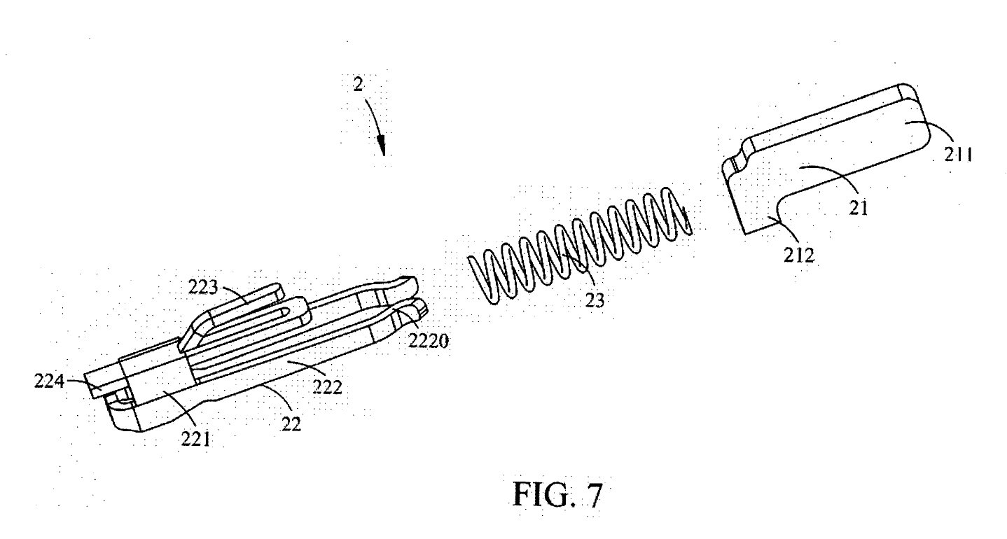

Referring to FIG. 1 to 4, according to a preferred embodiment of the invention, an electrical connector includes an insulator 1, on which a plurality of accommodating holes are formed, a plurality of terminals 2 accommodated in the accommodating holes, and a plurality of solder pads 3 by which the electrical connector is capable of being soldered on a PCB. The insulator 1 is substantially in the shape of a cuboid, and it has a top wall 11, a bottom wall 12, and left and right arms 13, 14 formed on the ends of the insulator 1. Therein, a plurality of accommodating holes 112 are formed with a big opening end thereof and the other small opening end thereof between the top wall 11 and the bottom wall 12, and the accommodating holes 112 are formed through the insulator 1 for accommodating the terminals 2. A plurality of slot openings 121 are formed under the accommodating holes 112 on the bottom wall 12. An accommodating slot 134 is respectively formed on the left and right arms 13, 14 for accommodating the solder pads. Each of the terminals 2 includes a first terminal 21, a second terminal 22, and a resilient member 23 urging against the first terminal 21 and disposed between the first terminal 21 and the second terminal 22, as shown in FIG. 5. Therein, the first terminal 21 is substantially in the shape of a plate, of which the front end has a contact portion 211, and the rear end has a stop 212; the contact portion 211 is disposed protrusively out of the surface of the insulator 1, as shown in FIG. 2. As shown in FIG. 6 and FIG. 7, the second terminal 22 has a body 221, two resilient arms 222 formed and extended from the sides of the body 221, a conducting portion 223 formed and extended forward from the body 221 above the two resilient arms 222, and a connecting portion 224 formed and extended backward. The connecting portion 224 is used for connecting to a strip of raw material. A holding portion 2220 is formed on the ends of the two resilient arms 222 for resiliently holding onto the sides of the first terminal 21. The resilient member 23 is disposed in the space formed by the two resilient arms 222 (in the preferred embodiment, the resilient member 23 is a spring) and maintains contact with the first terminal 21 and the second terminal 22 during operation.

When assembling, the resilient arm 23 is first disposed between the two resilient arms 222. Next, the first terminal 21 is held between the holding portion 2220 of the two resilient arms 222 such that the rear surface of the first terminal 21 contacts the top surface of the resilient member 23. Then, each of the terminals 2 is respectively disposed in one of the accommodating holes 112 such that the conducting portion 223 passes through the slot opening 121 and held in the slot opening 121. Finally, the solder pads 3 are disposed in the accommodating slots 134.

With the recitations of the preferred embodiment above, the features and spirits of the invention will be hopefully well described. However, the scope of the invention is not restricted by the preferred embodiment disclosed above. The objective is that all alternative and equivalent arrangements are hopefully covered in the scope of the appended claims of the invention. Accordingly, the above disclosure should be construed as limited only by the metes and bounds of the appended claims.

What is claimed is:

1. An electrical connector, comprising:
an insulator comprising a plurality of accommodating holes; and
a plurality of terminals accommodated in the accommodating holes, each of the terminals comprising a first terminal, a second terminal, and a resilient member urging against the first terminal, wherein the resilient member is disposed between the first terminal and the second terminal.

2. The electrical connector of claim 1, wherein a contact portion is formed on the front end of the first terminal.

3. The electrical connector of claim 2, wherein the contact portion is disposed protrusively out of the surface of the insulator.

4. The electrical connector of claim 1, wherein a stop is formed on the rear end of the first terminal.

5. The electrical connector of claim 1, wherein the second terminal has a body and two resilient arms.

6. The electrical connector of claim 5, wherein a holding portion is formed on the ends of the two resilient arms, and the holding portion holds the first terminal.

7. The electrical connector of claim 5, wherein the resilient arms are formed and extended from the body, and the resilient member is disposed between the resilient arms.

8. The electrical connector of claim 5, wherein a conducting portion is formed and extended forward from the body above the two resilient arms.

9. The electrical connector of claim 5, wherein a connecting portion is formed and extended backward from the body, and the connecting portion is used for connecting a strip.

10. The electrical connector of claim 1, wherein the resilient member is a spring.
